(19) United States
(12) Patent Application Publication
(10) Pub. No.: US 2017/0362349 A1
(43) Pub. Date: Dec. 21, 2017

(54) PHOTOPOLYMER COMPRISING A NEW CLASS OF PHOTO INITATOR

(71) Applicant: Covestro Deutschland AG, Leverkusen (DE)

(72) Inventors: KOICHI KAWAMURA, Odenthal (DE); Thomas RÖLLE, Leverkusen (DE); Horst BERNETH, Leverkusen (DE); Dennis HÖnel, Zülpich-Wichterich (DE); Friedrich-Karl BRUDER, Krefeld (DE)

(21) Appl. No.: 15/535,820

(22) PCT Filed: Dec. 11, 2015
(86) PCT No.: PCT/EP2015/079377

§ 371 Date: Jun. 14, 2017

(30) Foreign Application Priority Data
Dec. 17, 2014 (EP) 14198411.2

(51) Int. Cl. C08F 2/50; C09B 69/06; C09B 23/01; G11B 7/245; G11B 7/24044; C08F 12/26

(52) U.S. Cl. CPC C08F 2/50; G11B 7/245; G11B 7/24044; C09B 69/06; C09B 23/0091; C08F 12/26

(57) ABSTRACT

The present invention relates to photopolymer comprising a photopolymerizable component and a photo initiator system. Further aspects of the present invention are a holographic media which comprises such a photopolymer, a display which comprises such a holographic media and the use of such a holographic media to make chip cards, security documents, bank notes and/or holographic optical elements especially for displays.

The present invention relates to a photopolymer comprising a photopolymerizable component and a photo initiator system. Further aspects of the present invention are a holographic media which comprises such a photopolymer, a display which comprises such a holographic media and the use of such holographic media to make chip cards, security documents, bank notes and or holographic optical elements especially for displays.

Photopolymers which can especially be used to make holographic media are known in the art. WO 2012/062655 for example discloses photopolymers which comprise three dimensional cross linked polyurethane matrix polymers, acrylate writing monomers and a photo initiator system. Holographic media made from these photopolymers show excellent holographic performance.

The holographic performance of photopolymer is decisively determined by the refractive index modulation Δn produced in the photopolymer by holographic exposure. In holographic exposure, the interference field of signal light beam and reference light beam (in the simplest case, that of two plane waves) is mapped into a refractive index grating by the local photopolymerization of, for example, high refractive index acrylates at loci of high intensity in the interference field. The refractive index grating in the photopolymer (the hologram) contains all the information of the signal light beam. Illuminating the hologram with only the reference light beam will then reconstruct the signal. The strength of the signal thus reconstructed relative to the strength of the incident reference light is diffraction efficiency, DE in what follows.

In the simplest case of a hologram resulting from the superposition of two plane waves, the DE is the ratio of the intensity of the light diffracted on reconstruction to the sum total of the intensities of the incident reference light and the diffracted light. The higher the DE, the greater the efficiency of a hologram with regard to the amount of reference light needed to visualize the signal with a fixed brightness.

When the hologram is illuminated with white light, for example, the width of the spectral range which can contribute to reconstructing the hologram is likewise only dependent on the layer thickness d. The relationship which holds is that the smaller the thickness d, the greater the particular spectral bandwidth will be. Therefore, to produce bright and easily visible holograms, it is generally desirable to seek a high Δn and a low thickness d while maximizing DE. That is, increasing Δn increases the latitude to engineer the layer thickness d without loss of DE for bright holograms. Therefore, the optimization of Δn is of outstanding importance in the optimization of photopolymer formulations (P. Hariharan, Optical Holography, 2nd Edition, Cambridge University Press, 1996).

Another important property of photopolymers for holographic media is their sensitivity to light which is used during the writing process. As the light intensity of light sources suitable for hologram recording is limited by the availability of such lasers it is desirable to provide photopolymers with a high sensitivity, i.e. photopolymers into which holograms can be recorded with the lowest possible light intensity.

It was thus an object of the present invention to provide a photopolymer for holographic media having a higher sensitivity compared to known holographic media as for example disclosed in WO 2012/062655.

This object is solved by a photopolymer comprising a photopolymerizable component and a photo initiator system, in which the photo initiator system comprises a compound according to formula (I)

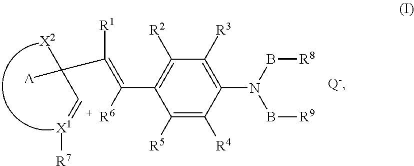

in which
R¹ to R⁶ are independently of each other hydrogen, halogen, alkyl, cyano, carboxyl, alkanoyl, aroyl, alkoxy, aryl, alkoxycarbonyl, aminocarbonyl, which can be further substituted, mono- or dialkylamino;
A is together with X¹ and X² and the atoms connecting them independently of each other a five- or six-membered aromatic or quasiaromatic or partially hydrogenated heterocyclic ring which may each contain 1 to 4 heteroatoms and/or be benzo- or naphtha-fused and/or be substituted by nonionic moieties, in which case the chain attaches to the ring in position 2 or 4 relative to X¹,
X¹ is nitrogen, or
X¹—R⁷ is O or S;

X² is O, S, N—R¹⁰, C(R¹¹)₂ or CR¹²R¹³;
R⁷ and R¹⁰ are independently of each other alkyl, alkenyl, cycloalkyl or aralkyl;
R¹¹ is hydrogen or alkyl,
R¹² and R¹³ are independently of each other C₁- to C₄-alkyl, C₃- to C₆-alkenyl, C₄- to C₇-cycloalkyl or C₇- to C₁₀-aralkyl or conjointly form a —CH₂—CH₂—CH₂—CH₂— or —CH₂—CH₂—CH₂—CH₂—CH₂— bridge,
Q is a monovalent anion;
R⁸ and R⁹ are independently of each other substituents with a Harnett substituent constant σₘ>0.3, and
B is a connecting group containing 1 or 2 carbon atoms.

In another embodiment of the invention the object is a photopolymer comprising a photopolymerizable component and a photo initiator system, in which the photo initiator system comprises a compound according to formula (I)

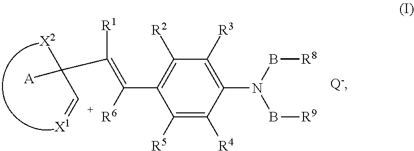

in which
R¹ to R⁶ are independently of each other hydrogen, halogen, alkyl, cyano, carboxyl, alkanoyl, aroyl, alkoxy, aryl, alkoxycarbonyl, aminocarbonyl, which can be further substituted, mono- or dialkylamino;
A is together with X¹ and X² and the atoms connecting them independently of each other a five- or six-membered aromatic or quasiaromatic or partially hydrogenated heterocyclic ring which may each contain 1 to 4 heteroatoms and/or be benzo- or naphtha-fused and/or be substituted by nonionic moieties, in which case the chain attaches to the ring in position 2 or 4 relative to X¹,
X¹ is O, S, or N—R⁷;
X² is O, S, N—R¹⁰, CR¹²R¹³, if ring A is a five-membered ring and X² is C(R¹¹)₂, if ring A is a six-membered ring;
R⁷ and R¹⁰ are independently of each other alkyl, alkenyl, cycloalkyl or aralkyl;
R¹¹ is hydrogen or alkyl,
R¹² and R¹³ are independently of each other C₁- to C₄-alkyl, C₃- to C₆-alkenyl, C₄- to C₇-cycloalkyl or C₇- to C₁₀-aralkyl or conjointly form a CH₂—CH₂—CH₂—CH₂— or —CH₂—CH₂—CH₂—CH₂—CH₂— bridge,
Q is a monovalent anion;
R⁸ and R⁹ are independently of each other substituents with a Hammett substituent constant σₘ>0.3, and
A is a connecting group containing 1 or 2 carbon atoms.

Surprisingly it has be found that photopolymers with a photo initiator comprising a compound according to formula (I) can be used to make holographic media with a very high sensitivity to light.

A comprehensive collection Hammett substituent constants σₘ can be found in Chem. Rev. 1991, 91, 165-195, “A Survey of Hammett Substituent Constants and Resonance and Field Parameters.

According to a first preferred embodiment of the invention R⁸ and R⁹ are independently of each other substituents with a Hammett substituent constant σₘ>0.34 and <0.90.

According to another preferred embodiment of the invention B—R⁸ and B—R⁹ are independently of each other substituents with a Hammett substituent constant σₘ>0.34 and <0.90.

It is also preferred if R⁸ and R⁹ are independently of each other alkoxycarbonyalkyl, halogen substituted alkyl, cyano substituted alkyl, acyl substituted alkyl, amido substituted alkyl, or R⁸ and R⁹ together form imido substituted alkyl.

Still further preferred is when R⁸ and R⁹ are independently of each other alkoxycarbonyethyl, alkoxycarbony-methyl, halogen substituted methyl, halogen substituted ethyl, cyano substituted methyl, cyano substituted ethyl, acyl substituted methyl, acyl substituted ethyl, amido substituted ethyl, amido substituted methyl, imido substituted methyl.

It is also preferred if B—R⁸ and B—R⁹ are independently of each other alkoxycarbonyalkyl, halogen substituted alkyl, cyano substituted alkyl, acyl substituted alkyl, amido substituted alkyl, or B—R⁸ and B—R⁹ together form imido substituted alkyl.

Still further preferred is when B—R⁸ and B—R⁹ are independently of each other alkoxycarbonyethyl, alkoxycarbonymethyl, halogen substituted methyl, halogen substituted ethyl, cyano substituted methyl, cyano substituted ethyl, acyl substituted methyl, acyl substituted ethyl, amido substituted ethyl, amido substituted methyl, imido substituted methyl.

R¹ to R⁶ may preferably hydrogen, halogen, alkyl, cyano, alkoxycarbonyl.

R² to R⁵ may be hydrogen or halogen, alkyl, cyano, alkoxycarbonyl, whereby only one of the three radicals may be different from hydrogen.

Halogen may preferably be either fluorine, chlorine or bromine.

R³ may preferably be bromine.

R⁵ may preferably be methyl and chlorine.

R⁶ may especially be methyl or hydrogen.

In another embodiment, R⁶ may most preferably be hydrogen.

R⁶ may especially be methyl or hydrogen and R¹ may especially be cyano or hydrogen.

A, X¹ and X² may preferably be a five- or six-membered aromatic or quasiaromatic or partially hydrogenated heterocyclic ring which may each contain 1 to 2 heteroatoms and/or be benzo-fused.

Another preferred embodiment is characterized in that R⁷ and R¹⁰ are independently of each other C₁- to C₁₆-alkyl, C₃- to C₆-alkenyl, C₅- to C₇-cycloalkyl or C₇- to C₁₆-aralkyl. Even more preferred is when R⁷ and R¹⁰ are independently of each C₁- to C₁₀-alkyl.

With formula (I) R¹¹ may preferably be hydrogen or C₁- to C₄-alkyl, and is most preferably methyl.

In another embodiment, R¹¹ may most preferably be hydrogen.

R¹² and R¹³ may preferably be methyl, conjointly form a —CH₂—CH₂—CH₂—C₂— or —CH₂—CH₂—CH₂—CH₂—CH₂— bridge.

In another embodiment, R¹² and R¹³ may most preferably be methyl.

It is also preferred if X¹ is —N.

Q is preferably a borate anion, a halogen anion, a sulfonate anion, a carboxylate anion, a perchlorate anion or a phosphonate anion.

In another embodiment of the invention. Q is preferably a borate anion, a halogen anion, a sulfonate anion, a carboxylate anion, a perchlorate anion or a phosphonate anion, with the proviso that Q⁻ is not hexylbenzenesulfonate, 4-octylbenzenesulfonate, 4-decylbenzene-sulfonate or 4-dodecylbenzenesulfonate.

B may preferably be methylene (—CH₂—) or ethylene (—CH₂—CH₂—) unit.

The photopolymer may comprise 0.01 to 5.00 weight-%, preferably 0.03 to 2.00 weight-% and most preferably 0.05 to 0.50 weight-% of the compound according to formula (I).

The photo initiator system may preferably further comprise at least one co-initiator, selected from carbonyl initiators, borate initiators, trichloromethyl initiators, aryloxide initiators, bisimidazole initiators, ferrocene initiators, aminoalkyl initiators, oxime initiator, thiol initiators, peroxide initiators. Examples of the co-initiator include carbonyl compounds such as benzoin ethyl ether, benzophenone, and diethoxyacetophertone; acylphosphine oxide compounds such as 2,4,6-trimethylbenzoyldiphenylphosphine oxide and bis(2,4,6-trimethylbenzoyl)phenylphosphine oxide; organic tin compounds such as tributylbenzyltin; alkylaryl borates such as tetrabutylammonium triphenylbutylborate, tetrabutylammonium tris(tert-butylphenyl)butylborate, and tetrabutylammonium trinaphtylbutylborate; diaryliodonium salts such as diphenyliodonium hexafluorophosphate, diphenyliodonium tetrafluoroborate, and diphenyliodonium hexafluoroantimonate; iron arene complexes such as (η5-cyclopenta-dienyl)(η6-cumenyl)-iron hexafluorophosphate; triazine compounds such as tris(trichloro-methyl)triazine; organic peroxides such as 3,3′-di(tert-butylperoxycarbortyl)-4,4′-di-(methoxyearbonyl)benzophenone, 3,3′,4,4′-tetrakis(tert-butylperoxycarbonyl)benzophenone, di-tert-butylperoxyisophthalate, 2,5-dimethyl-2,5-bis(benzoylperoxy)hexane, and tert-butyl-peroxy benzoate; and bis-imidazole derivatives such as 2,2′-bis(o-chlorophenyl)-4,4′,5,5′-tetraphenyl-1,1′-bis-imidazole.

According to still another preferred embodiment the photopolymer may further comprises matrix polymers. The matrix polymers may especially be three dimensional cross-linked and more preferably three dimensional cross-linked polyurethanes.

Such three dimensional cross-linked polyurethanes matrix polymers can for example be obtained by reacting a polyisocyanate component a) and an isocyanate-reactive component b).

The polyisocyanate component a) comprises at least one organic compound having at least two NCO groups. These organic compounds may especially be monomeric di- and triisocyanates, polyisocyanates and/or NCO-functional prepolymers. The polyisocyanate component a) may also contain or consist of mixtures of monomeric di- and triisocyanates, polyisocyanates and/or NCO-functional prepolymers.

Monomeric di- and triisocyanates used may be any of the compounds that are well known per se to those skilled in the art, or mixtures thereof. These compounds may have aromatic, araliphatic, aliphatic or cycloaliphatic structures. The monomeric di- and triisocyanates may also comprise minor amounts of monoisocyanates, i.e. organic compounds having one NCO group.

Examples of suitable monomeric di- and triisocyanates are butane 1,4-diisocyanate, pentane 1,5-diisocyanate, hexane 1,6-diisocyanate (hexamethylene diisocyanate, HDI), 2,2,4-trimethylhexamethylene diisocyanate and/or 2,4,4-trimethylhexamethylene diisocyanate (TMDI), isophorone diisocyanate (IPDI), 1,8-diisocyanate-4-(isocyanatomethyl)octane, bis-(4,4′-isocyanatocyclohexyl)methane and/or bis(2′,4-isocyanatocyclohexyl)methane and/or mixtures thereof having any isomer content, cyclohexane 1,4-diisocyanate, the isomeric bis-(isocyanatotnethyl)cyclohexanes, 2,4- and/or 2,6-diisocyanato-1-methylcyclohexane (hexa-hydrotolylene 2,4- and/or 2,6-diisocyanate, H₆-TDI), phenylene 1,4-diisocyanate, tolylene 2,4- and/or 2,6-diisocyanate (TDI), naphthylene 1,5-diisocyanate (NDI), diphenylmethane 2,4′- and/or 4,4′-diisocyanate (MDI), 1,3-bis(isocyanatomethyl)benzene (XDI) and/or the analogous 1,4 isomers or any desired mixtures of the aforementioned compounds.

Suitable polyisocyanates are also compounds which have urethane, urea, carbodiirnide, acylurea, amide, isocyanurate, allophanate, biuret, oxadiazinetrione, uretdione and/or iminooxadiazinedione structures and are obtainable from the aforementioned di- or triisocyanates.

More preferably, the polyisocyanates are oligomerized aliphatic and/or cycloaliphatic di- or triisocyanates, it being possible to use especially the above aliphatic and/or cycloaliphatic di- or triisocyanates.

Very particular preference is given to polyisocyanates having isocyanurate, uretdione and/or iminooxadiazinedione structures, and biurets based on HDI or mixtures thereof.

Suitable prepolymers contain urethane and/or urea groups, and optionally further structures formed through modification of NCO groups as specified above. Prepolymers of this kind are obtainable, for example, by reaction of the abovementioned monomeric di- and triisocyanates and/or polyisocyanates a1) with isocyanate-reactive compounds b1).

Isocyanate-reactive compounds b1) used may be alcohols, amino or mercapto compounds, preferably alcohols. These may especially be polyols. Most preferably, isocyanate-reactive compounds b1) used may be polyester polyols, polyether polyols, polycarbonate polyols, poly(meth)acrylate polyols and/or polyurethane polyols.

Suitable polyester polyols are, for example, linear polyester diols or branched polyester polyols, which can be obtained in a known manner by reaction of aliphatic, cycloaliphatic or aromatic di- or polycarboxylic acids or anhydrides thereof with polyhydric alcohols of OH functionality ≧2. Examples of suitable di- or polycarboxylic acids are polybasic carboxylic acids such as succinic acid, adipic acid, suberic acid, sebacic acid, decanedicarboxylic acid, phthalic acid, terephthalic acid, isophthalic acid, tetrahydrophthalic acid or trimellitic acid, and acid anhydrides such as phthalic anhydride, trimellitic anhydride or succinic anhydride, or any desired mixtures thereof. The polyester polyols may also be based on natural raw materials such as castor oil. It is likewise possible that the polyester polyols are based on home- or copolymers of lactones, which can preferably be obtained by addition of lactones or lactone mixtures, such as butyrolactone, r-caprolactone and/or methyl-ε-caprolactone onto hydroxy-functional compounds such as polyhydric alcohols of OH functionality ≧2, for example of the abovementioned type.

Examples of suitable alcohols are all polyhydric alcohols, for example the C₂-C₁₂ diols, the isomeric cyclohexanediols, glycerol or any desired mixtures thereof.

Suitable polycarbonate polyols are obtainable in a manner known per se by reaction of organic carbonates or phosgene with diols or diol mixtures.

Suitable organic carbonates are dimethyl, diethyl and diphenyl carbonate.

Suitable diols or mixtures comprise the polyhydric alcohols of OH functionality ≧2 mentioned per se in the context of the polyester segments, preferably butane-1,4-diol, hexane-1,6-diol and/or 3-methylpentanediol. It is also possible to convert polyester polyols to polycarbonate polyols.

Suitable polyether polyols are polyaddition products, optionally of block like structure, of cyclic ethers onto OH- or NH-functional starter molecules.

Suitable cyclic ethers are, for example, styrene oxides, ethylene oxide, propylene oxide, tetrahydrofuran, butylene oxide, epichlorohydrin, and any desired mixtures thereof.

Starters used may be the polyhydric alcohols of OH functionality ≧2 mentioned per se in the context of the polyester polyols, and also primary or secondary amines and amino alcohols.

Preferred polyether polyols are those of the aforementioned type based exclusively on propylene oxide, or random or block copolymers based on propylene oxide with further 1-alkylene oxides. Particular preference is given to propylene oxide homopolymers and random or block copolymers containing oxyethylene, oxypropylene and/or oxybutylene units, where the proportion of the oxypropylene units based on the total amount of all the oxyethylene, oxypropylene and oxybutylene units amounts to at least 20% by weight, preferably at least 45% by weight. Oxypropylene and oxybutylene here encompasses all the respective linear and branched C₃ and C₄ isomers.

Additionally suitable as constituents of the polyol component b1), as polyfunctional, isocyanate-reactive compounds, are also low molecular weight (i.e. with molecular weights ≦500 g/mol), short-chain (i.e. containing 2 to 20 carbon atoms), aliphatic, araliphatic or cycloaliphatic di-, tri- or polyfunctional alcohols.

These may, for example, in addition to the abovementioned compounds, be neopentyl glycol, 2-ethyl-2-butylpropanediol, trimethylpentanediol, positionally isomeric diethyloctanediols, cyclohexanediol, 1,4-cyclohexanedimethanol, 1,6-hexanediol, 1,2- and 1,4-cyclohexanediol, hydrogenated bisphenol A, 2,2-bis(4-hydroxycyclohexyl)propane or 2,2-dimethyl-3-hydroxypropyl 2,2-dimethyl-3-hydroxypropionate. Examples of suitable triols are tri-methylolethane, trimethylolpropane or glycerol. Suitable higher-functionality alcohols are di(trimethylolpropane), pentaerythritol, dipentaerythritol or sorbitol.

It is especially preferable when the polyol component is a difunctional polyether, polyester, or a polyether-polyester block copolyester or a polyether-polyester block copolymer having primary OH functions.

It is likewise possible to use amines as isocyanate-reactive compounds b1). Examples of suitable amines are ethylenediamine, propylenediamine, diaminocyclohexane, 4,4′-dicyclohexylmethanediamine, isophoronediamine (IPDA), difunctional polyamines, for example the Jeffamines®, amine-terminated polymers, especially having number-average molar masses ≦10 000 g/mol. Mixtures of the aforementioned amines can likewise be used.

It is likewise possible to use amino alcohols as isocyanate-reactive compounds b1). Examples of suitable amino alcohols are the isomeric aminoethanols, the isomeric aminopropanols, the isomeric ainirlobutanols and the isomeric aminohexanols, or any desired mixtures thereof.

All the aforementioned isocyanate-reactive compounds b1) can be mixed with one another as desired.

It is also preferable when the isocyanate-reactive compounds b1) have a number-average molar mass of ≧200 and ≦10 000 g/mol, further preferably ≧500 and ≦8000 g/mol and most preferably ≧800 and ≦5000 g/mol. The OH functionality of the polyols is preferably 1.5 to 6.0, more preferably 1.8 to 4.0.

The prepolymers of the polyisocyanate component a) may especially have a residual content of free monomeric di- and triisocyanates of <1% by weight, more preferably <0.5% by weight and most preferably <0.3% by weight.

It is optionally also possible that the polyisocyanate component a) contains, entirely or in part, organic compound whose NCO groups have been fully or partly reacted with blocking agents known from coating technology. Example of blocking agents are alcohols, lactams, oximes, malonic esters, pyrazoles, and amines, for example butanone oxime, diisopropyl-amine, diethyl malonate, ethyl acetoacetate, 3,5-dimethylpyrazole, ε-caprolactam, or mixtures thereof.

It is especially preferable when the polyisocyanate component a) comprises compounds having aliphatically bonded NCO groups, aliphatically bonded NCO groups being under-stood to mean those groups that are bonded to a primary carbon atom.

The isocyanate reactive component b) preferably comprises at least one organic compound having an average of at least 1.5 and preferably 2 to 3 isocyanate-reactive groups. In the context of the present invention, isocyanate-reactive groups are regarded as being preferably hydroxyl, amino or mercapto groups.

The isocyanate-reactive component may especially comprise compounds having a numerical average of at least 1.5 and preferably 2 to 3 isocyanate-reactive groups.

Suitable polyfunctional, isocyanate-reactive compounds of the component b) are, for example, the above-described compounds b1), including all the preferred embodiments mentioned for the component b1).

Further examples of suitable polyethers and processes for preparation thereof are described in EP 2 172 503 A1, the disclosure of which in this regard is hereby incorporated by reference.

Reaction of the polyisocyanate component a) with the isocyanate-reactive component b) gives rise to a polymeric matrix material. More preferably, this matrix material is consisting of addition products of butyrolactone, ε-caprolactone and/or methyl-ε-caprolactone onto polyether polyols of a functionality of ≧1.8 and ≦3.1 having number-average molar masses of ≧200 and ≦4000 g/mol in conjunction with isocyanurates, uretdiones, iminooxadiazinediones and/or other oligomers based on HDI. Very particular preference is given to addition products of ε-caprolactone onto poly(tetrahydrofurans) having a functionality of ≧1.9 and ≦2.2 and number-average molar masses of ≧500 and ≦2000 g/mol, especially of ≧600 and ≦1400 g/mol, having a total number-average molar mass of ≧800 and ≦4500 g/mol, especially of ≧1000 and ≦3000 g/mol, in conjunction with oligomers, isocyanurates and/or iminooxadiazinediones based on HDI.

It is also possible that the photopolymer further comprises monomeric fluorourethanes and preferably monomeric fluorourethanes according to formula (II)

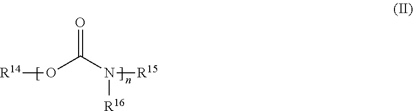

in which n is ≧1 and n is ≦8 and R¹⁴, R¹⁵, le are hydrogen and/or, independently of one another, linear, branched, cyclic or heterocyclic organic rests which are unsubstituted or optionally also substituted by heteroatoms, at least one of the residues R¹⁴, R¹⁵, R¹⁶ being substituted by at least one fluorine atom.

In a further preferred embodiment, the photopolymerizable component comprises or consists of at least one mono- and/or one multifunctional monomer. Further preferably, the photopolymerizable component may comprise or consist of at least one mono- and/or one multifunctional (meth)acrylate monomers. Most preferably, the photopolymerizable component may comprise or consist of at least one mono- and/or one multifunctional urethane (meth)acrylate.

Suitable acrylate monomers are especially compounds of the general formula (III)

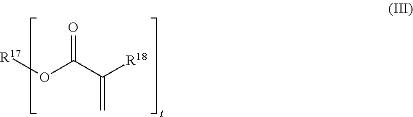

in which t≧1 and t≦4 and R¹⁷ is a linear, branched, cyclic or heterocyclic organic radical which is unsubstituted or else optionally substituted by heteroatoms and/or R¹⁸ is hydrogen or a linear, branched, cyclic or heterocyclic organic radical which is unsubstituted or else optionally substituted by heteroatoms. More preferably, R¹⁸ is hydrogen or methyl and/or R¹⁷ is a linear, branched, cyclic or heterocyclic organic radical which is unsubstituted or else optionally substituted by heteroatoms.

Acrylates and methacrylates refer, respectively, to esters of acrylic acid and methacrylic acid. Examples of acrylates and methacrylates usable with preference are phenyl acrylate, phenyl methacrylate, phenoxyethyl acrylate, phenoxyethyl methacrylate, phenoxyethoxyethyl acrylate, phenoxyethoxyethyl methacrylate, phenylthioethyl acrylate, phenylthioethyl methacrylate, 2-naphthyl acrylate, 2-naphthyl methacrylate, 1,4-bis(2-thionaphthyl)-2-butyl acrylate, 1,4-bis(2-thionaphthyl)-2-butyl methacrylate, bisphenol A di-acrylate, bisphenol A dimethacrylate, and the ethoxylated analogue compounds thereof, N-carbazolyl acrylates.

Urethane acrylates mean compounds having at least one acrylic ester group and at least one urethane bond. Compounds of this kind can be obtained, for example, by reacting a hydroxy-functional acrylate or methacrylate with an isocyanate-functional compound.

Examples of isocyanate-functional compounds usable for this purpose are mono isocyanates, and the monomeric diisocyanates, triisocyanates and/or polyisocyanates mentioned under a). Examples of suitable monoisocyanates are phenyl isocyanate, the isomeric methylthiophenyl isocyanates. Di-, tri- or polyisocyanates have been mentioned above, and also triphenyl-methane 4,4′,4″-triisocyanate and tris(p-isocyanatophenyl) thiophosphate or derivatives thereof with urethane, urea, carbodiimide, acylurea, isocyanurate, allophanate, biuret, oxadiazinetrione, uretdione, iminooxadiazinedione structure and mixtures thereof. Preference is given to aromatic di-, tri- or polyisocyanates.

Useful hydroxy-functional acrylates or methacrylates for the preparation of urethane acrylates include, for example, compounds such as 2-hydroxyethyl (meth)acrylate, polyethylene oxide mono(meth)acrylates, polypropylene oxide mono(meth)acrylates, poly-alkylene oxide mono(meth)acrylates, poly(ε-caprolactone) mono(meth)acrylates, for example Tone® M100 (Dow, Schwalbach, Del.), 2-hydroxypropyl (meth)acrylate, 4-hydroxybutyl (meth)acrylate, 3-hydroxy-2,2-dimethylpropyl (meth)acrylate, hydroxypropyl (meth)acrylate, 2-hydroxy-3-phenoxypropyl acrylate, the hydroxy-functional mono-, di- or tetraacrylates of polyhydric alcohols such as trimethylolpropane, glycerol, pentaerythritol, dipentaerythritol, ethoxylated, propoxylated or alkoxylated trimethylolpropane, glycerol, pentaerythritol, dipcntaerythritol or the technical mixtures thereof. Preference is given to 2-hydroxyethyl acrylate, hydroxypropyl acrylate, 4-hydroxybutyl acrylate and poly(ε-caprolactone) mono(meth)acrylate.

It is likewise possible to use the fundamentally known hydroxyl-containing epoxy (meth)-acrylates having OH contents of 20 to 300 mg KOH/g or hydroxyl-containing polyurethane (meth)acrylates having OH contents of 20 to 300 mg KOH/g or acrylated polyacrylates having OH contents of 20 to 300 mg KOH/g and mixtures thereof, and mixtures with hydroxyl-containing unsaturated polyesters and mixtures with polyester (meth)acrylates or mixtures of hydroxyl-containing unsaturated polyesters with polyester (meth)acrylates.

Preference is given especially to urethane acrylates obtainable from the reaction of tris(p-isocyanatophenyl) thiophosphate and/or m-methylthiophenyl isocyanate with alcohol-functional acrylates such as hydroxyethyl (meth)acrylate, hydroxypropyl (meth)acrylate and/or hydroxybutyl (meth)acrylate.

It is likewise possible that the photopolymerizable component comprises or consists of further unsaturated compounds such as α,β-unsaturated carboxylic acid derivatives, for example maleates, fumarates, maleimides, acrylamides, and also vinyl ethers, propenyl ethers, allyl ethers and compounds containing dicyclopentadienyl units, and also olefinically unsaturated compounds, for example styrene, α-methylstyrene, vinyltoluene and/or olefins.

However it is especially preferred if the photopolymerizable component comprises a mono- and/or multifunctional urethane-(meth)-acrylate.

The photopolymer may further comprise cationic polymerizable compounds such as cationic initiators, cationic polymerizable monomers or cationic polymerizable plasticizers as referred in US 20130034805A.

Another aspect of the present invention is a holographic media which comprises a photopolymer according to the invention.

The holographic media may contain or consist of the abovementioned photopolymer.

The photopolymer can especially be used for production of holographic media in the form of a film. In this case, a ply of a material or material composite transparent to light within the visible spectral range (transmission greater than 85% within the wavelength range from 400 to 780 nm) as carrier is coated on one or both sides, and a cover layer is optionally applied to the photopolymer ply or plies.

The invention therefore also provides a process for producing a holographic medium, in which
(I) an inventive photopolymer is produced by mixing all the constituents,
(II) the photopolymer is converted to the form desired for the holographic medium at a processing temperature and
(III) cured in the desired form with urethane formation at a crosslinking temperature above the processing temperature.

Preferably, the photopolymer is produced in step I) by mixing the individual constituents.

Preferably, the photopolymer is converted in step II) to the form of a film. For this purpose, the photopolymer can be applied, for example, over the area of a carrier substrate, in which case, for example, the apparatuses known to those skilled in the art (doctor blade, knife-over-roll, comma bar, inter glia) or a slot die can be used. The processing temperature here can be in the range of 20 to 40° C., preferably in the range of 20 to 30° C.

The carrier substrate used may be a ply of a material or material composite transparent to light in the visible spectral range (transmission greater than 85% in the wavelength range from 400 to 800 nm).

Preferred materials or material composites for the carrier substrate are based on polycarbonate (PC), polyethylene terephthalate (PET), polybutylene terephthalate, polyethylene, polypropylene, cellulose acetate, cellulose hydrate, cellulose nitrate, cyclooletin polymers, polystyrene, polyepoxides, polysulphone, cellulose triacetate (CTA), polyamide, polymethylmethacrylate, polyvinyl chloride, polyvinyl butyral or polydicyclopentadiene or mixtures thereof. They are more preferably based on PC, PET and CTA. Material composites may be film laminates or coextrudates. Preferred material composites are duplex and triplex films formed according to one of the schemes A/B, A/B/A or A/B/C. Particular preference is given to PC/PET, PET/PC/PET and PC/TPU (TPU=thermoplastic polyurethane).

As an alternative to the aforementioned carrier substrates, it is also possible to use planar glass panes, which find use especially for large-area, high-accuracy exposures, for example for holographic lithography (Holographic interference lithography for integrated optics, IEEE Transactions on Electron Devices (1978), ED-25(10), 1193-1200, ISSN:0018-9383).

The materials or material composites of the carrier substrate may be given an antiadhesive, antistatic, hydrophobized or hydrophilized finish on one or both sides. The modifications mentioned serve the purpose, on the side facing the photopolymer, of making the photopolymer detachable without destruction from the carrier substrate. Modification of the opposite side of the carrier substrate from the photopolymer serves to ensure that the inventive media satisfy specific mechanical demands which exist, for example, in the case of processing in roll laminators, especially in roll-to-roll processes.

The carrier substrate may be coated on one or both sides.

The invention also provides a holographic medium obtainable by the process according to the invention.

The invention further provides a laminate structure comprising a carrier substrate, an inventive holographic medium applied thereto, and optionally a cover layer applied to the opposite side of the holographic medium from the carrier substrate.

The laminate structure may especially have one or more cover layers on the holographic medium in order to protect it from soil and environmental influences. For this purpose, it is possible to use polymer films or film composite systems, or further clearcoats.

The cover layers used are preferably film materials analogous to the materials used in the carrier substrate, and these may have a thickness of typically 5 to 200 μm, preferably 8 to 125 μm, more preferably 10 to 50 μm.

Preference is given to cover layers having a very smooth surface. A measure used here is the roughness, determined to DIN EN ISO 4288 “Geometrical Product Specifications (GPS)—Surface texture . . . ”, test condition: R3z front and reverse sides. Preferred roughnesses are in the region of less than or equal to 2 μm, preferably less than or equal to 0.5 μm.

The cover layers used are preferably PE or PET films of thickness 20 to 60 ore preferably, a polyethylene film having a thickness of 40 μm is used.

It is likewise possible that, in the case of a laminate structure on the carrier substrate, a further cover layer is applied as a protective layer.

In a preferred embodiment of the holographic media at least one hologram is recorded into it.

The inventive holographic media can be processed to holograms by means of appropriate recording processes for optical applications over the entire visible range (400-800 nm). Visual holograms include all holograms which can be recorded by methods known to those skilled in the art. These include in-line (Gabor) holograms, off-axis holograms, full-aperture transfer holograms, white light transmission holograms (“rainbow holograms”), Denisyuk holograms, off-axis reflection holograms, edge-lit holograms and holographic stereograms. Preference is given to reflection holograms, Denisyuk holograms, transmission holograms.

Possible optical functions of the holograms correspond to the optical functions of light elements such as lenses, mirrors, deflecting mirrors, filters, diffuser lenses, diffraction elements, light guides, waveguides, projection lenses and/or masks. These optical elements frequently have a frequency selectivity according to how the holograms have been exposed and the dimensions of the hologram.

In addition it is also possible to produce holographic images or representations, for example for personal portraits, biometric representations in security documents, or generally of images or image structures for advertising, security labels, brand protection, branding, labels, design elements, decorations, illustrations, collectable cards, images and the like, and also images which can represent digital data, including in combination with the products detailed above. Holographic images can have the impression of a three-dimensional image, but they may also represent image sequences, short films or a number of different objects according to the angle from which and the light source with which (including moving light sources) etc. they are illuminated. Because of this variety of possible designs, holograms, especially volume holograms, constitute an attractive technical solution for the abovementioned application.

Still another aspect of the present invention is a display comprising a holographic media according to the invention.

Examples for such displays are three dimensional displays, head-up displays, head-down displays in vehicles, displays in windows, on glasses, displays integrated in eye glasses.

Also the use of a holographic media according to the invention to make chip cards, security documents, bank notes and/or holographic optical elements especially for displays is an aspect of the present invention.

The invention will be described in more detail by the following examples.

### Starting Materials:

Starting materials to synthesize C1-C13 were prepared according to procedures reported in the literature.

In the synthesis of C1, 4′-[N,N-bis(2-chloroethyl)amino]benzaldehyde was prepared according to Huang, Chibao; Qu, Junle; Qi, Jing; Yan, Meng; Xu, Gaixia, Organic Letters, 2011, vol. 13, 1462-1465.

In the synthesis of C2, N-[2-cyanoethyl)-N-(cyanomethyl)amino]benzaldehyde was prepared according to Liao, Yi; Robinson, Bruce H. Tetrahedron Letters, 2004, vol. 45, 1473-1475.

In the synthesis of C3, C4, C7-C13, N-[2-cyanoethyl)-4-[N,N-di(ethoxycarbonylmethyl)-amino]-benzaldehyde [1208-03-3] was prepared according to Kumari, Namita; Jha, Satadru; Bhattacharya, Santanu, Journal of Organic Chemistry, 2011, vol. 76, 8215-8222.

In the synthesis of C5, C6, 3-bromo-4-[N,N-di(ethoxycarbonylinethypamino]-benzaldehyde was prepared according to Venkateswarlu, Katta; Suneel, Kanaparthy; Das, Biswanath; Reddy, Kuravallapalli Nagabhusharia; Reddy, Thummala Sreenivasulu, Synthetic Communications, 2009, vol. 39, p. 215-219.

In the synthesis of C11, 1-ethyl-4-methyl pyridinium was prepared according to Kim, Min Ji; Shin, Seung Hoon; Kim, Young Jin; Cheong, Minserk; Lee, Je Seung; Kim, Hoon Sik, Journal of Physical Chemistry B, 2013, vol. 117, 14827-14834.

In the synthesis of C12, 3-ethyl-2-methyl-4,5-dihydrothiazolium was prepared according to Zimmermann, Thomas, Journal of Heterocyclic Chemistry, 1999, vol. 36, 813-818.

In the synthesis of C13, 1-ethyl-2-methyl pyridinium was prepared according to Kim, Min Ji; Shin, Seung Hoon; Kim, Young Jin; Cheong, Minserk; Lee, Je Seung; Kim, Hoon Sik, Journal of Physical Chemistry B, 201, vol. 117, 14827-14834.

The reagents and solvents used were acquired commercially.
CGI-909 Tetrabutylammonium tris(3-chloro-4-methylphenyl)(hexyl)borate, [1147315-11-4] is a product produced by BASF SE, Basle, Switzerland.
Desmorapid Z Dibutyltin dilaurate [77-58-7], product from Bayer MaterialScience AG, Leverkusen, Germany.
Desmodur® N 3900 Product from Bayer MaterialScience AG, Leverkusen, Germany, hexane diisocyanate-based polyisocyanate, iminooxadiazinedione content at least 30%, NCO content: 23.5%.
Fomrez UL 28 Urethanization catalyst, commercial product of Momentive Performance Chemicals, Wilton, Conn., USA.

### Test Methods:

### Isocyanate Content (NCO Value)

The isocyanate contents reported were determined according to DIN EN ISO 11909.

### Preparation of Dyes:

### Synthesis of C1

1.24 g of N,N-bis(2-chloroethyl)amino-benzaldehyde and 0.87 g of 1,3,3-trimethyl-2-methylene indoline were mixed in a flask containing 3 mL of acetic anhydride and 9 mL of acetic acid and heated at 90° C. for 6 h. The reaction mixture was poured into 50 mL of water, stirred for 30 min and filtered. A solution of 1.72 g of sodium tetraphenyl borate in 10 mL of water was added to the filtered solution and the solid which was precipitated was filtered and collected. Dried at 50° C. Reddish orange powder.

Yield 2.43 g (67%) λₘₐₓ 512 nm (AN).

### Synthesis of C2

0.85 g of N-(2-cyanoethyl),N-(cyanomethyl)amino-benzaldehyde and 0.69 g of 1,3,3-trimethyl-2-methylene indoline were mixed in a flask containing 3 mL of acetic anhydride and 9 mL of acetic acid and heated at 90 C for 6 h. The reaction mixture was poured into 50 mL of water, stirred for 30 min and filtered. A solution of 1.36 g of sodium tetraphenyl borate in 10 mL of water was added to the filtered solution and the solid which was precipitated was collected by filtration. Dried at 50° C. Reddish orange powder.

Yield 1.91 g (70%) λₘₐₓ 476 nm (AN).

### Synthesis of C3

2.93 g of 4-[N,N-di(ethoxycarbonylmethyl)amino]-benzaldehyde and 1.73 g of 1,3,3-tris methyl-2-methylene indoline were mixed in a flask containing 6 mL of acetic anhydride and 18 mL of acetic acid and heated at 80° C. for 3 h. The reaction mixture was poured into 50 mL of water, stirred for 30 min and filtered. A solution of 3.42 g of sodium tetraphenyl borate in 25 mL of methanol was added to the filtered solution and the solid which was precipitated was collected by filtration. Orange powder.

Yield 4.76 g (62%) λₘₐₓ 511 nm (AcOEt).

### Synthesis of C4

1.40 g of 4-[N,N-di(ethoxycarbonylmethyl)amino]-benzaldehyde and 0.83 g of 1,3,3-trimethyl-2-methylene indoline were mixed in a flask containing 6 mL of acetic anhydride and 18 mL of acetic acid and heated at 80° C. for 3 h. The reaction mixture was poured into 100 m1, of water, stirred for 30 min and filtered. A solution of 1.71 g of sodium bis(2-ethylhexyl) sulfosuccinate in 100 mL of ethyl acetate was added to the filtered solution and the mixture was extracted with 100 mL of ethyl acetate. The ethyl acetate solution was separated, dried with magnesium sulfate and evaporated to give red oil.

Yield 3.1 g (92%) λₘₐₓ 503 nm (AcOEt).

### Synthesis of C5

0.70 g of 3-bromo-4-[N,N-di(ethoxycarbonylmethyl)amino]-benzaldehyde and 0.32 g of 1,3,3-trimethyl-2-methylene indoline were mixed in a flask containing 6 mL of acetic anhydride and 18 mL of acetic acid and heated at 80° C. for 3 h. The reaction mixture was poured into 50 m1, of water, stirred for 30 min and filtered. A solution of 0.64 g of sodium tetraphenyl borate in 25 mL of methanol was added to the filtered solution and the solid which was precipitated was collected by filtration. Orange powder.

Yield 1.29 g (81%) λₘₐₓ 469 nm (AcOEt).

### Synthesis of C6

Using 1.70 g of 3-bromo-4-[N,N-di(ethoxycarbonylmethyl)amino]-benzaldehyde and 0.87 g of 1,3,3-trimethyl-2-methylene indoline as starting materials. Same procedure as synthetic example C3. Red oil.

Yield 2.8 g (88%) λₘₐₓ 456 run (AcOEt).

### Synthesis of C7

Using 2.0 g of 4-[N,N-di(ethoxycarbonylmethyl)amino]-benzaldehyde, 1.41 g of 5-chloro-1,3,3-trimethyl-2-methylene indoline and 2.33 g of sodium tetraphenyl borate as starting materials. Same procedure as synthetic example C4. Reddish orange powder.

Yield 3.8 g (70%) λₘₐₓ 428 nm (AcOEt).

### Synthesis of C8

Using 2.0 g of 4-[N,N-di(ethoxycarbonylmethyl)amino]-benzaldehyde, 1.41 g of 5-chloro-1,3,3-trimethyl-2-methylene indoline and 2.33 g of sodium tetraphenyl borate as starting materials. Same procedure as synthetic example C4. Reddish orange powder.

Yield 3.8 g (70%) λₘₐₓ 428 nm (AcOEt).

### Synthesis of C9

2.1 g of [N,N-di(ethoxycarbonylmethyl)amino]-benzaldehyde and 1.5 g of 2-(1,3,3-tri-methylindolin-2-ylidene)acetonitrile were mixed in a flask containing 1.2 g of phosphoryl chloride and 20 mL of toluene and heated at 70° C. for 3 h. The reaction mixture was poured into 50 mL of water, stirred for 30 min and filtered. A solution of 2.59 g of sodium tetraphenyl borate in 25 mL of methanol was added to the filtered solution and extracted with ethyl acetate and the extract was evaporated. After purification by column chromatography (silica gel, cyclohexane/ethyl acetate V:V=1:2 as eluent) gave reddish oil.

Yield 0.7 g (23%) λₘₐₓ 520 nm (AcOEt).

### Synthesis of C10

2.0 g of [N,N-di(ethoxycarbonylmethyl)amino]-benzaldehyde and 2.2 g of 3-ethyl-2-methyl benzthiazolium ethylsulfate were mixed in a flask containing 20 mL of pyridine and heated at 1.10° C. for 3 h. The reaction mixture was poured into 50 mL of water, stirred for 30 min and filtered. A solution of 2.46 g of sodium tetraphenyl borate in 25 mL of methanol was added to the filtered solution and the solid which was precipitated was collected by filtration and recrystallized from ethanol. Orange powder.

Yield 3.40 g (64%) λₘₐₓ 496 nm (AcOEt)

### Synthesis of C11

1.39 g of 4-[N,N-di(ethoxycarbonylmethyl)amino]-benzaldehyde and 1.30 g of 1-ethyl-4-methyl pyridinium ethylsulfate were mixed in a flask containing 0.39 g of ammonium acetate, 0.30 g of acetic acid and 50 mL of acetonitrile and heated at 100° C. for overnight. The reaction mixture was poured into 50 mL of water, stirred for 30 min and filtered. A solution of 2.46 g of sodium tetraphenyl borate in 25 mL of methanol was added to the filtered solution and the solid which was precipitated was collected by filtration. The solid was refluxed with 100 mL of methanol for 30 min and filtrated. The filtered solution was evaporated to yield of product as orange powder.

Yield 1.2 g, λₘₐₓ 450 nm (AN).

### Synthesis of C12

1.39 g of 4-[N,N-di(ethoxycarbonylmethyl)amino]-benzaldehyde and 1.30 g of 3-ethyl-2-methyl thiazolium ethylsulfate were mixed in a flask containing 0.77 g of ammonium acetate, 0.60 g of acetic acid and 50 mL of acetonitrile and heated at 100° C. for 3 days. The reaction mixture was poured into 50 mL of water, stirred for 30 min and filtered. A solution of 2.63 g of sodium tetraphenyl borate in 25 mL of methanol was added to the filtered solution and the solid which was precipitated was collected by filtration. The solid was washed with 100 mL of methanol and filtrated. The filtered solution was evaporated to yield of product as orange oil.

Yield 0.9 g, λₘₐₓ 444 nm (AN).

### Synthesis of C13

0.70 g of 4-[N,N-di(ethoxycarbonylmethyl)amino]-benzaldehyde and 0.66 g of 1-ethyl-2-methyl pyridinium ethylsulfate were mixed in a flask containing 0.50 g of piperidine and 50 mL of acetonitrile and heated at 100° C. for overnight. The reaction mixture was poured into 50 mL of water, stirred for 30 min. A solution of 0.85 g of sodium tetraphenyl borate in 20 mL of methanol was added and filtered. The filtered solution was extracted with 300 mL of ethyl acetate and evaporated to yield of product as orange oil.

Yield 0.89 g (50%), λₘₐₓ 422 nm (AN).

### Reference Compounds RC1 and RC2

The preparation of RC1 is described in EP 10190324.3, Example 18. The preparation of RC2 is described in EP 10190324.3, Example 17.

The spectroscopic properties of the compounds C1-C13 and of the reference compounds RC1, RC2 are compiled in table 1. The solvents use were acetonitrile (AN) and ethyl acetate (AcOEt), respectively. The suitable laser wavelength given are examples for commercially well available lasers.

TABLE 1
Examples of Compounds

| | | | Absorp- | Suitable |
|---|---|---|---|---|
| | | | | laser |
| | | | tion λₘₐₓ | wavelength |
| NO. | Dye cation | Anion | (Solvent) | (nm) |
| C1 | 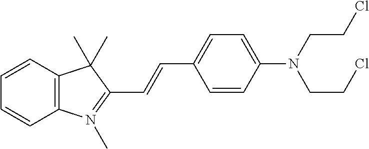 | 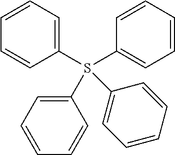 [SMILES: c1ccc(S(c2ccccc2)(c2ccccc2)c2ccccc2)cc1] | 512 (AN) | 532 |
| C2 | 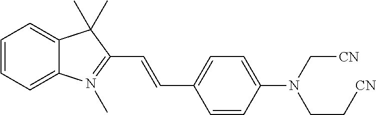 | 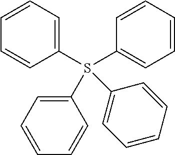 [SMILES: c1ccc(S(c2ccccc2)(c2ccccc2)c2ccccc2)cc1] | 476 (AN) | 532, 473, 455 |
| C3 | 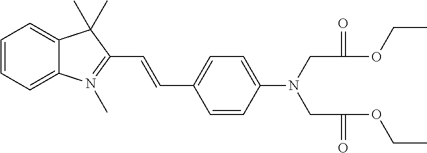 | 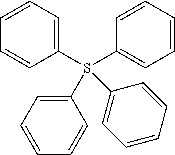 [SMILES: c1ccc(S(c2ccccc2)(c2ccccc2)c2ccccc2)cc1] | 511 (AcOEt) | 532 |
| C4 | 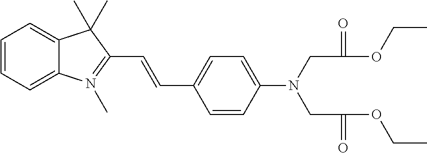 | 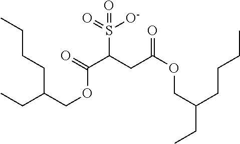 [SMILES: CCCCC(CC)COC(=O)CC(C(=O)OCC(CC)CCCC)S(=O)(=O)[O-]] | 503 (AcOEt) | 532 |
| C5 | 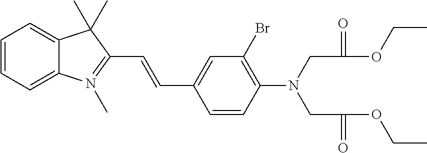 | 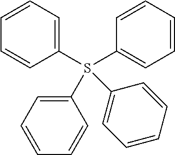 [SMILES: c1ccc(S(c2ccccc2)(c2ccccc2)c2ccccc2)cc1] | 469 (AcOEt) | 532, 473, 455 |
| C6 | 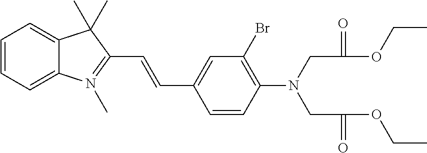 | 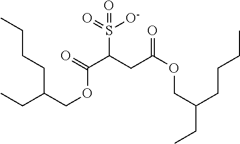 [SMILES: CCCCC(CC)COC(=O)CC(C(=O)OCC(CC)CCCC)S(=O)(=O)[O-]] | 456 (AcOEt) | 532, 473, 455 |
| C7 | 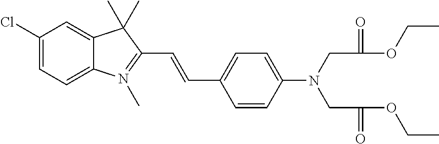 | 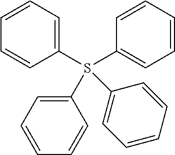 [SMILES: c1ccc(S(c2ccccc2)(c2ccccc2)c2ccccc2)cc1] | 528 (AcOEt) | 532 |
| C8 | 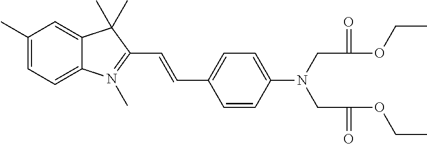 | 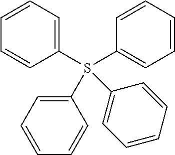 [SMILES: c1ccc(S(c2ccccc2)(c2ccccc2)c2ccccc2)cc1] | 511 (AcOEt) | 532 |
| C9 | 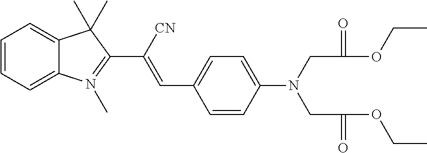 | 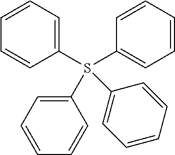 [SMILES: c1ccc(S(c2ccccc2)(c2ccccc2)c2ccccc2)cc1] | 520 (AcOEt) | 532 |
| C10 | 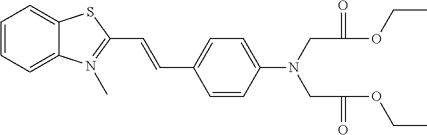 | 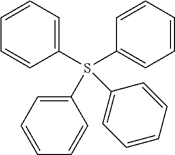 [SMILES: c1ccc(S(c2ccccc2)(c2ccccc2)c2ccccc2)cc1] | 496 (AcOEt) | 532, 473, 455 |
| C11 | 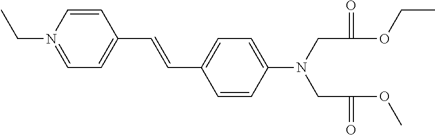 | 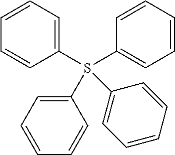 [SMILES: c1ccc(S(c2ccccc2)(c2ccccc2)c2ccccc2)cc1] | 450 (AN) | 473, 455 |
| C12 | 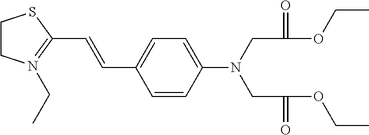 | 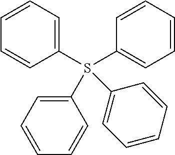 [SMILES: c1ccc(S(c2ccccc2)(c2ccccc2)c2ccccc2)cc1] | 444 (AN) | 473, 455 |
| C13 | 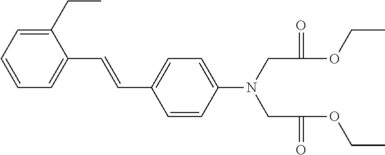 [SMILES: CCOC(=O)CN(CC(=O)OCC)c1ccc(/C=C/c2ccccc2CC)cc1] | 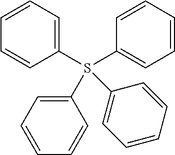 [SMILES: c1ccc(S(c2ccccc2)(c2ccccc2)c2ccccc2)cc1] | 442 (AN) | 473, 455 |

Reference compound

| | | | | |
|---|---|---|---|---|
| RC1 | 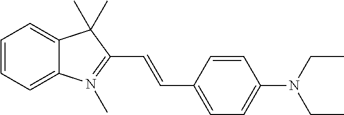 | 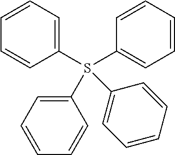 | 548 (AN) | 532 |
| RC2 | 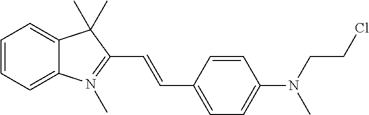 | 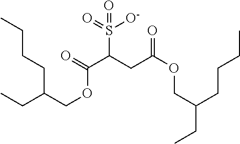 | 527 (AN) | 532 |

### Preparation a Photopolymer Compounds

### Preparation of Polyol 1

In a 1 L flask, 0.18 g of tin octoate, 374.8 g of ε-caprolactone and 374.8 g of a difunctional polytetrahydrofuran polyetherpolyol (equivalent weight 500 g/mol of OH) were initially charged and heated up to 120° C. and maintained at that temperature until the solids content (proportion of nonvolatile constituents) was 99.5% by weight or higher. This was followed by cooling to obtain the product as a waxy solid.

### Preparation of Acrylate 1: (phosphorus thioyltris(oxy-4,1-phenyleneiminocarbonyloxy-ethane-2,1-diyl)triacrylate)

In a 500 mL round-bottom flask, 0.1 g of 2,6-di-tert-butyl-4-methylphenol, 0.05 g of dibutyltin dilaurate (Desmorapid® Z, Bayer MaterialScience AG, Leverkusen, Germany) and also and 213.07 g of a 27% solution of tris(p-isocyanatophenyl) thiophosphate in ethyl acetate (Desmodur® RFE, product from Bayer MaterialScience AG, Leverkusen, Germany) were initially charged and heated to 60° C. Thereafter, 42.37 g of 2-hydroxyethyl acrylate were added dropwise and the mixture was further maintained at 60° C. until the isocyanate content had dropped below 0.1%. This was followed by cooling and complete removal of the ethyl acetate under reduced pressure to obtain the product as a partly crystalline solid.

### Preparation of Acrylate 2: 2-({[3-(methylsulphanyl)phenyl]carbamoyl}oxy)ethyl prop-2-enoate)

In a 100 mL round-bottom flask, 0.02 g of 2,6-di-tert-butyl-4-methylphenol, 0.01 g of Desmorapid® Z, 11.7 g of 3-(methylthio)phenyl isocyanate were initially charged and heated to 60° C. Thereafter, 8.2 g of 2-hydroxyethyl acrylate were added dropwise and the mixture was further maintained at 60° C. until the isocyanate content had dropped below 0.1%, This was followed by cooling to obtain the product as a pale yellow liquid.

### Preparation of Additive 1: (Bis(2,2,3,3,4,4,5,5,6,6,7,7-dodecafluoroheptyl) 2,2,4-tri-methylhexane-1,6-diyl biscarbamate)

In a round-bottom flask, 0.02 g of Desmorapid Z and 3.6 g of 2,4,4-trimethylhexanes 1,6-diisocyanate were initially charged and heated to 70° C. This was followed by the dropwise addition of 11.39 g of 2,2,3,3,4,4,5,5,6,6,7,7-dodecafluoroheptan-1-ol and the mixture was further maintained at 70° C. until the isocyanate content had dropped below 0.1%. This was followed by cooling to obtain the product as a colorless oil.

### Preparation of Holographic Media

### Example Medium 1 (M1-M10) and Reference (RM1-RM2)

3.38 g of polyol component 1 were mixed with 2.00 g of acrylate 1, 2.00 g of acrylate 2, 1.50 g of additive 1, 0.10 g of CGI 909 (product from BASF SE, Basle, Switzerland), 0.018 g of dye from Table 1 and 0.35 g of ethyl acetate at 40° C. to obtain a clear solution. The solution was then cooled down to 30° C., 0.65 g of Desmodur® N3900 (commercial product from Bayer MaterialScience AG, Leverkusen, Germany, hexane diisocyanate-based polyisocyanate, portion on iminooxadiazinedione at least 30%, NCO content: 23.5%) was added before renewed mixing. Finally, 0.01 g of Fomrez UL 28 (urethanization catalyst, commercial product of Momentive Performance Chemicals, Wilton, Conn., USA) was added and again briefly mixed in. The mixed photopolymer formulation was applied on 36 μm thick polyethylene terephthalate film. The coated film was dried for 5.8 minutes at 80° C. and finally covered with a 40 μm polyethylene film. The achieved photopolymer layer thickness was around 14 μm.

### Holographic Testing:

### Measurement of the Holographic Properties of Diffraction Efficiency DE and Refractive Index Contrast an of the Holographic Media by Means of Twin-Beam Interference in a Reflection Arrangement.

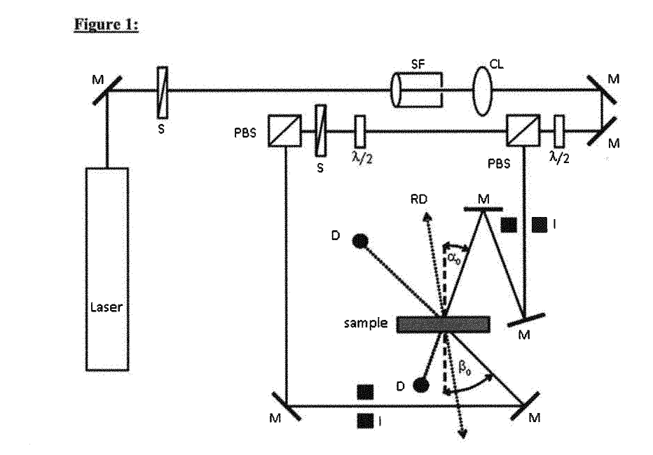

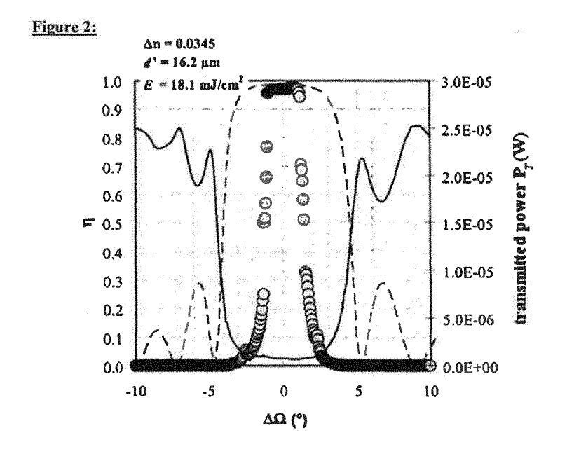

A holographic test setup as shown in FIG. 1 was used to measure the diffraction efficiency (DE) of the media. The beam of a DPSS laser (emission wavelength 532 nm) was converted to a parallel homogeneous beam with the aid of the spatial filter (SF) and together with the collimation lens (CL). The final cross sections of the signal and reference beam are fixed by the iris diaphragms (1). The diameter of the iris diaphragm opening is 0.4 cm. The polarization-dependent beam splitters (PBS) split the laser beam into two coherent beams of identical polarization. By means of the λ/2 plates, the power of the reference beam was set to 0.87 mW and the power of the signal beam to 1.13 mW. The powers were determined using the semiconductor detectors (D) with the sample removed. The angle of incidence (α₀) of the reference beam is −21.8°; the angle of incidence (β₀) of the signal beam is 41.8°. The angles are measured proceeding from the sample normal to the beam direction. According to FIG. 2, therefore, α₀ has a negative sign and β₀ a positive sign. At the location of the sample (medium), the interference field of the two overlapping beams produced a pattern of light and dark strips parallel to the angle bisectors of the two beams incident on the sample (reflection hologram). The strip spacing Λ, also called grating period, in the medium is 188 nm (the refractive index of the medium assumed to be ˜4.504).

FIG. 1 shows the geometry of a holographic media tester (HMT) at λ=532 nm (DPSS laser): M=mirror, S=shutter, SF=spatial filter, CL=collimator lens, λ/2=λ/2 plate, PBS=polarization-sensitive beam splitter, D=detector, I=iris diaphragm, α₀=−21.8°, β₀=41.8° are the angles of incidence of the coherent beams measured outside the sample (outside the medium). RD=reference direction of the turntable.

Holograms were recorded in the medium in the following manner:
Both shutters (S) are opened for the exposure time t.
Thereafter, with the shutters (S) closed, the medium is allowed 5 minutes for the diffusion of the as yet unpolymerized writing monomers.

The holograms recorded were then reconstructed in the following manner. The shutter of the signal beam remained closed. The shutter of the reference beam was opened. The iris diaphragm of the reference beam was closed to a diameter of <1 mm. This ensured that the beam was always completely within the previously recorded hologram for all angles of rotation (Ω) of the medium. The turntable, under computer control, swept over the angle range from Ωₘᵢₙ to Ωₘₐₓ with an angle step width of 0.05°. Ω is measured from the sample normal to the reference direction of the turntable. The reference direction of the turntable is obtained when the angles of incidence of the reference beam and of the signal beam have the same absolute value on recording of the hologram, i.e. α₀=−31.8° and β₀=31.8°. In that case, Ω_{recording}=0°. When α₀=−21.8° and β₀=41.8°, Ω_{recording} is therefore 10°. In general, for the interference field in the course of recording of the hologram:

α₀=θ₀+Ω_{recording}.

θ₀ is the semiangle in the laboratory system outside the medium and, in the course of recording of the hologram:

$${θ}_{0} = \frac{{α}_{0} - {β}_{0}}{2} .$$

Thus, in this case, θ₀=−31.8°. At each setting for the angle of rotation Ω, the powers of the beam transmitted in the zeroth order were measured by means of the corresponding detector D, and the powers of the beam diffracted in the first order by means of the detector D. The diffraction efficiency was calculated at each setting of angle Ω as the quotient of:

$$η = \frac{{P}_{D}}{{P}_{D} + {P}_{T}}$$

P_{D} is the power in the detector for the diffracted beam and P_{T} is the power in the detector for the transmitted beam.

By means of the process described above, the Bragg curve, which describes the diffraction efficiency η as a function of the angle of rotation Ω for the recorded hologram, was measured and saved on a computer. In addition, the intensity transmitted into the zeroth order was also recorded against the angle of rotation Ω and saved on a computer.

The maximum diffraction efficiency (DE=ηₘₐₓ) of the hologram, i.e. the peak value thereof, was determined at Ω_{reconstruction}. In some cases, it was necessary for this purpose to change the position of the detector for the diffracted beam in order to determine this maximum value.

The refractive index contrast Δn and the thickness d of the photopolymer layer were now determined by means of coupled wave theory (see: 1-1. Kogelnik, The Bell System Technical Journal, Volume 48, November 1969, Number 9 page 2909—page 2947) from the measured Bragg curve and the variation of the transmitted intensity with angle. In this context, it should be noted that, because of the shrinkage in thickness which occurs as a result of the photopolymerization, the strip spacing Δ′ of the hologram and the orientation of the strips (slant) can differ from the strip spacing Δ of the interference pattern and the orientation thereof. Accordingly, the angle α₀′ and the corresponding angle of the turntable Ω_{reconstruction} at which maximum diffraction efficiency is achieved will also differ from α₀ and from the corresponding Ω_{recording}. This alters the Bragg condition. This alteration is taken into account in the evaluation process. The evaluation process is described hereinafter:

All geometric parameters which relate to the recorded hologram and not to the interference pattern are shown as parameters with primes.

For the Bragg curve η(Ω) of a reflection hologram, according to Kogelnik:

$$η = \{ \begin{matrix}\frac{1}{1 - \frac{1 - {( ξ / v )}^{2}}{{sin}^{2} ( \sqrt{{ξ}^{2} - {v}^{2}} )}} , for {v}^{2} - {ξ}^{2} < 0 \\ \frac{1}{1 + \frac{1 - {( ξ / v )}^{2}}{{sinh}^{2} ( \sqrt{{v}^{2} - {ξ}^{2}} )}} , for {v}^{2} - {ξ}^{2} \geq 0\end{matrix} \\ with \text{:} \\ v = \frac{π \cdot Δ n \cdot {d}^{′}}{λ \cdot \sqrt{\vert {c}_{x} \cdot {c}_{r} \vert}} \\ ξ = - \frac{{d}^{′}}{2 \cdot {c}_{s}} \cdot DP \\ {c}_{s} = cos ( {ϑ}^{′} ) - cos ( {ψ}^{′} ) \cdot \frac{λ}{n \cdot {Λ}^{′}} \\ {c}_{r} = cos ( {ϑ}^{′} ) \\ DP = \frac{π}{{Λ}^{′}} \cdot ( 2 \cdot cos ( {ψ}^{′} - {ϑ}^{′} ) - \frac{λ}{n \cdot {Λ}^{′}} ) \\ {ψ}^{′} = \frac{{β}^{′} + {α}^{′}}{2} \\ {Λ}^{′} = \frac{λ}{2 \cdot n \cdot cos ( {ψ}^{′} - {α}^{′} )}$$

In the reconstruction of the hologram, as explained analogously above:

[symbol]

′₀=η₀+Ω

sin( [symbol] ′₀)=n·sin( [symbol] ′)

Under the Bragg condition, the “dephasing” DP=0. And it follows correspondingly that:

α′₀=θ₀+Ω_{reconstruction}

sin(α′₀)=n·sin(α′)

The as yet unknown angle β′ can be determined from the comparison of the Bragg condition of the interference field in the course of recording of the hologram and the Bragg condition in the course of reconstruction of the hologram, assuming that only shrinkage in thickness takes place. It then follows that:

$$sin ( {β}^{′} ) = \frac{1}{n} \cdot [ sin ( {α}_{0} ) + sin ( {β}_{0} ) - sin ( {θ}_{0} + {Ω}_{reconstruction} ) ]$$

v is the grating thickness, ξ is the detuning parameter and ψ′ is the orientation (slant) of the refractive index grating which has been recorded. α′ and β′ correspond to the angles α₀ and β₀ of the interference field in the course of recording of the hologram, except measured in the medium and applying to the grating of the hologram (after shrinkage in thickness). n is the mean refractive index of the photopolymer and was set to 1.504. λ is the wavelength of the laser light in the vacuum.

The maximum diffraction efficiency (DE=ηₘₐₓ), when ξ=0, is then calculated to be:

$$DE = {tanh}^{2} ( v ) = {tanh}^{2} ( \frac{π \cdot Δ n \cdot {d}^{′}}{λ \cdot \sqrt{cos ( {α}^{′} ) \cdot cos ( {α}^{′} - 2 ψ )}} )$$

FIG. 2 shows the measured transmitted power P_{T} (right-hand y-axis) plotted as a solid line against the angle detuning ΔΩ; the measured diffraction efficiency η (left-hand y-axis) plotted as filled circles against the angle detuning ΔΩ (to the extent allowed by the finite size of the detector), and the fitting to the Kogelnik theory as a broken line (left-hand y-axis).

The measured data for the diffraction efficiency, the theoretical Bragg curve and the transmitted intensity are, as shown in FIG. 2, plotted against the centered angle of rotation ΔΩ≡Ω_{reconstruction}=Ω=α′₀− [symbol] ′₀, also called angle detuning.

Since DE is known, the shape of the theoretical Bragg curve, according to Kogelnik, is determined only by the thickness d′ of the photopolymer layer. An is corrected via DE for a given thickness d′ such that measurement and theory for DE are always in agreement. d′ is adjusted until the angle positions of the first secondary minima of the theoretical Bragg curve correspond to the angle positions of the first secondary maxima of the transmitted intensity, and there is additionally agreement in the full width at half maximum (FWHM) for the theoretical Bragg curve and for the transmitted intensity.

Since the direction in which a reflection hologram also rotates when reconstructed by means of an Ω scan, but the detector for the diffracted light can cover only a finite angle range, the Bragg curve of broad holograms (small d′) is not fully covered in an Ω scan, but rather only the central region, given suitable detector positioning. Therefore, the shape of the transmitted intensity, which is complementary to the Bragg curve, is additionally employed for adjustment of the layer thickness d′.

FIG. 2 shows the plot of the Bragg curve η according to the coupled wave theory (broken line), the measured diffraction efficiency (filled circles) and the transmitted power (black solid line) against the angle detuning ΔΩ.

For a formulation, this procedure was repeated, possibly several times, for different exposure times t on different media, in order to find the mean energy dose of the incident laser beam in the course of recording of the hologram at which DE reaches the saturation value. The mean energy dose E is calculated as follows from the powers of the two component beams assigned to the angles α₀ and β₀ (reference beam where Pᵣ=0.87 mW and signal beam where Pₛ=1.13 mW), the exposure time t and the diameter of the iris diaphragm (0.4 cm):

$$E ( mJ / {cm}^{2} ) = \frac{2 \cdot [ {P}_{r} + {P}_{s} ] \cdot t ( s )}{π \cdot {0.4}^{2} {cm}^{2}}$$

The powers of the component beams were adjusted such that the same power density is attained in the medium at the angles α₀ and β₀ used.

In an alternative setup according to FIG. 1 a DPSS laser with an emission wavelength λ of 473 nm could be used. In this case α₀=−21.8° and β₀=41.8° are same as if using the emission wavelength λ=532 nm but the reference beam power was set to Pᵣ=1.31 mW and signal beam power was set to Pₛ=1.69 mW.

The media obtained as described were subsequently tested for their holographic properties in the manner described above using a measuring arrangement as FIG. 1. The following measurements were obtained for Δn at dose E [mJ/cm²]:

| | | Laser used to record | | | Dose |
|---|---|---|---|---|---|
| | Dye | Hologram (nm) | DE | Δn | (mJ/cm²) |
| Example | | | | | |
| test no | | | | | |
| M1 | C1 | 532 | 0.99 | 0.030 | 31.8 |
| M2 | C3 | 532 | 0.97 | 0.033 | 31.8 |
| M3 | C4 | 532 | 0.97 | 0.031 | 31.8 |
| M4 | C5 | 532 | 0.98 | 0.027 | 31.8 |
| M5 | C5 | 473 | 0.93 | 0.031 | 95.5 |
| M6 | C6 | 532 | 0.95 | 0.031 | 31.8 |
| M7 | C6 | 473 | 1.00 | 0.036 | 23.9 |
| M8 | C7 | 532 | 0.98 | 0.033 | 31.8 |
| M9 | C8 | 532 | 0.95 | 0.027 | 31.8 |
| M10 | C10 | 532 | 0.96 | 0.030 | 31.8 |
| Reference | | | | | |
| RM1 | RC1 | 532 | 0.93 | 0.018 | 31.8 |
| RM2 | RC2 | 532 | 0.97 | 0.025 | 31.8 |

The above experimental data shows that the inventive photopolymers possess a higher sensitivity to light compared to known holographic media, i.e. they have a higher DE and Δn if the same dose as for the references was used during holographic recording.

1.-18. (canceled)

19. A photopolymer comprising a photopolymerizable component and a photo initiator system, wherein the photo initiator system comprises a compound according to formula (I) 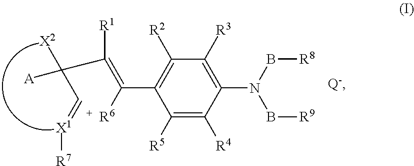
in which
R¹ to R⁶ are independently of each other hydrogen, halogen, alkyl, cyano, carboxyl, alkanoyl, aroyl, alkoxy, aryl, alkoxycarbonyl, aminocarbonyl, which can be further substituted mono- or dialkylamino;
A is together with X¹ and X² and the atoms connecting them independently of each other a five- or six-membered aromatic or quasiaromatic or partially hydrogenated heterocyclic ring which may each contain 1 to 4 heteroatoms and/or be benzo- or naphtho-fused and/or be substituted by nonionic moieties, in which case the chain attaches to the ring in position 2 or 4 relative to X¹,
X¹ is nitrogen, or
X¹—R⁷ is O or S;
X² is O, S, N—R¹⁰, C(R¹¹)₂ or CR¹²R¹³;
R⁷ and R¹⁰ are independently of each other alkyl, alkenyl, cycloalkyl or aralkyl;
R¹¹ is hydrogen or alkyl,
R¹² and R¹³ are independently of each other C₁- to C₄-alkyl, C₃- to C₆-alkenyl, C₄- to C₇-cycloalkyl or C₇- to C₁₀-aralkyl or conjointly form a CH₂—CH₂—CH₂—CH₂— or CH₂—CH₂—CH₂—CH₂—CH₂— bridge,
Q is a monovalent anion;
R⁸ and R⁹ are independently of each other substituents with a Hammett substituent constant σₘ>0.3
and B is a connecting group containing 1 or 2 carbon atoms.

20. The photopolymer according to claim 19, wherein R⁸ and R⁹ are independently of each other substituents with a Hammett substituent constant σₘ>0.34 and <0.90.

21. The photopolymer according to claim 19, wherein R⁸ and R⁹ are independently of each other alkoxycarbonyalkyl, halogen substituted alkyl, cyano substituted alkyl, acyl substituted alkyl, amido substituted alkyl, or R⁸ and R⁹ together form imido substituted alkyl.

22. The photopolymer according to claim 19, wherein R⁸ and R⁹ are independently of each other alkoxycarbonyethyl, alkoxycarbonymethyl, halogen substituted methyl, halogen substituted ethyl, cyano substituted methyl, cyano substituted ethyl, acyl substituted methyl, acyl substituted ethyl, amido substituted ethyl, amido substituted methyl, imido substituted methyl.

23. The photopolymer according to claim 19, wherein R⁷ and R¹⁰ are independently of each other C₁- to C₁₆-alkyl, C₃- to C₆-alkenyl, C₅- to C₇-cycloalkyl or C₇- to C₁₆-aralkyl.

24. The photopolymer according to claim 19, wherein R¹¹ is hydrogen or C₁- to C₄-alkyl, and is methyl.

25. The photopolymer according to claim 19, wherein X¹ is N.

26. The photopolymer according to claim 19, wherein R⁶ is methyl or hydrogen.

27. The photopolymer according to claim 19 comprising 0.01 to 5.00 weight-% of the compound according to formula (I).

28. The photopolymer according to claim 19, wherein the photo initiator system further comprises at least one co-initiator, selected from borate initiators, trichloromethyl initiators, aryloxide initiators, bisimidazole initiators, ferrocene initiators, aminoalkyl initiators, oxime initiator, thiol initiators, or peroxide intiators.

29. The photopolymer according to claim 19, wherein the photopolymer further comprises matrix polymers.

30. The photopolymer according to claim 29, wherein the matrix polymers are three dimensional cross-linked and preferably three dimensional cross-linked polyurethanes.

31. The photopolymer according to claim 19, wherein it further comprises monomeric fluorourethanes and preferably a monomeric fluorourethane according to formula (II) 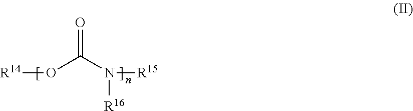
in which n is ≧1 and n is ≦8 and R¹⁴, R¹⁵, R¹⁶ are hydrogen and/or, independently of one another, linear, branched, cyclic or heterocyclic organic rests which are unsubstituted or optionally also substituted by heteroatoms, at least one of the rests R¹⁴, R¹⁵, R¹⁶ being substituted by at least one fluorine atom.

32. The photopolymer according to claim 19, wherein the photopolymerizable component comprises a mono- and/or multifunctional urethane-(meth)-acrylate.

33. A holographic media wherein it comprises a photopolymer according to claim 19.

34. The holographic media according to claim 33, wherein at least one hologram is recorded into the holographic media.

35. A display wherein it comprises a holographic media according to claim 34.

36. A method comprising utilizing the holographic media according to claim 33 to make chip cards, security documents, bank notes and/or holographic optical elements.
